(19) United States
(12) Patent Application Publication
(10) Pub. No.: US 2011/0272223 A1
(43) Pub. Date: Nov. 10, 2011

(54) VELOCITY LIMITER FOR AN ELEVATOR

(76) Inventors: Reto Drayer, Affoltern am Albis (CH); Rolf Fahrni, Luzern (CH)

(21) Appl. No.: 13/125,409

(22) PCT Filed: Oct. 23, 2009
(86) PCT No.: PCT/EP09/64018

§ 371 Date: Jul. 21, 2011

(30) Foreign Application Priority Data
Oct. 24, 2008 (EP) 08167549.8

(51) Int. Cl. B66B 5/04; B66B 1/26

(52) U.S. Cl. 188/65.1

(57) ABSTRACT

A velocity limiter in an elevator system includes a reset device for a brake of the velocity limiter, wherein the brake can be automatically triggered and released mechanically, and remotely so. The velocity limiter is equipped with a remotely-controllable triggering mechanism, for example a magnetic switch, and the reset device is equipped with a remotely-controllable drive system, for example a lift system.

### FIELD OF THE INVENTION

The present invention relates to an elevator installation in which, guided by way of rollers, an elevator car and a counterweight are motor-driven in an elevator shaft.

### BACKGROUND OF THE INVENTION

Such elevator installations are for safety reasons, but also in correspondence with technical standards and legal requirements, equipped with a safety brake device. The safety brake device is attached to the elevator car or to the counterweight and brakes movements of the elevator car or the counterweight and fixes the elevator car or the counterweight to, for example, guide rails of the elevator car and/or guide rails of the counterweight. Triggering of the safety brake device can be carried out, for example, in that the elevator car or the counterweight is coupled with a limiter cable by means of a linkage mechanism and lever mechanism. The limiter cable thus describes the movements of the elevator car or the counterweight conjunctively therewith and is guided at one end over a tensioning roller, but at the other end over a cable pulley of a speed limiter. In this regard the task is bestowed on the speed limiter of monitoring the speed of movement of the elevator car or the counterweight. In the case of exceeding the intended operating speeds the movement of the limiter cable is braked, whereby in turn the linkage and lever mechanism triggers the safety brake device.

The brake, which acts on the limiter cable, of the speed limiter can be constructed as a cable brake which presses one or more brake pads directly against the limiter cable.

U.S. Pat. No. 5,653,312 discloses a speed limiter with a cable brake in which centrifugal weights trigger closing of a spring-loaded cable safety brake device. After actuation of the cable safety brake device it is released again by means of a rod or brought back into its functionally capable initial setting, wherein the rod is attached as a lever in a hole provided for that purpose.

This described form of resetting the cable brake has, however, proved disadvantageous in practice. It requires effort in terms of servicing and represents a problem particularly when confined space conditions prevail for building and construction reasons. Many buildings demand, for example, elevator installations which manage with a small engine room, or even without an engine room, arranged above the elevator shaft so that it represents a problem to ensure the necessary capability of access for servicing personnel.

### SUMMARY OF THE INVENTION

An object of the present invention is to eliminate the stated disadvantages and to create a speed limiter for an elevator installation which needs reduced servicing effort and which is appropriate to confined space conditions in the engine room of an elevator installation or an elevator installation without an engine room.

Fulfillment of the set object consists on the one hand of a resetting device which is remotely operable. For this purpose the resetting device comprises a drive system which is so designed and arranged that it brings, by a resetting force of, for example, 1000 Newtons, the braking arm with the brake linings into its initial setting.

A pneumatic or hydraulic or a spindle drive or a rack drive, for example, which has actuating means disposed in another location, comes into consideration as the drive system. The force driving the drive system can also be produced by a repelling or attracting electromagnet. The drive system can be designed, regardless of the force driving it, as a pushing lift system or a traction system pulling by way of, for example, a deflecting roller.

The actuation of the drive system can be carried out by way of an electrical or electromagnetic switch or by way of a wire-free connection, for example an infrared or a radio connection, placed elsewhere. A mechanical actuation of the drive system by, for example, pulling away a securing of a spring standing under stress can in this regard represent a triggering which functions even in the case of power failure. In this regard a traction cable, as just described, can be responsible for actuation of the drive system, i.e. resetting of the brake, and a second cable, for example with force amplification by way of a block-and-tackle arrangement, can be responsible for resetting of the spring of the drive system, so that it can thereby be brought back into its operating setting.

A further variant of embodiment of the present invention provides a speed limiter with a corresponding resetting device which for simplified performance of safety tests and adjustments processes is also equipped, additionally to the remotely actuable resetting function, with a remotely actuable triggering function of the brake. This remote triggering can act on the trigger mechanism of the speed limiter and thereby trigger the brake.

Provided for the remote triggering is a magnetic switch which acts on a trigger lever, wherein the brake linings arranged at the free end of the brake arm come into contact with the limiter cable under the action of a spring-loaded brake lever. The brake linings or the mounting thereof is or are preferably formed to be wedge-shaped and displaceable, so that the brake linings can be automatically drawn into the actual braking position thereof by the arising friction and movement of the limiter cable.

In order to avoid the need for two separate drives, namely one for the remote resetting and one for the remote triggering, the resetting device according to the invention is preferably equipped with a drive which can under remote control execute not only the forward movement, but also the return movement.

The drive system is equipped with a roller where its force is applied to the brake, so that no unnecessary friction forces oppose unobstructed description of the working path.

The remote resetting and remote triggering, as disclosed herein, of a cable brake in a speed limiter is equally usable on speed limiters in which there is braking action not directly on the limiter cable, but on the cable pulley over which the limiter cable runs. The drive system according to the invention requires adaptation for that purpose insofar as its working direction has to be arranged to be turned in space through 90 degrees.

The speed limiter with a resetting device offers the following advantages:

After braking actions, but also in the case of system tests, a more rapid and simpler resetting of the brake of the speed limiter is possible.

A remotely actuable triggering of the brake is possible for safety tests and adjustment processes.

An engine room accommodating the speed limiter only has to be somewhat larger than the cable pulley of the speed limiter. The diameter of the cable pulley in that regard has to have, however, a certain size so that on the one hand a reliable contact friction with the limiter cable is ensured and on the other hand the limiter cable does not fall below the minimum bending radii fixed by standards.

The idea of a remotely actuable resetting device of the brake of the speed limiter is, however, also realizable in an elevator installation in which the speed limiter is arranged in the elevator shaft not to be stationary, but to run with the elevator car or the counterweight. In this regard the speed limiter runs on a limiter cable permanently tensioned between shaft floor and shaft ceiling or at a rail or rack and thus measures the speed of the elevator car or the counterweight directly by way of its own speed. The speed limiter can in this connection be designed so that in the case of exceeding the provided threshold value it directly triggers the safety brake device or also, according to an earlier principle, pulls the lever and linkage device of the safety brake device by way of a cable via a deflecting roller.

In the case of the two last-mentioned variants of embodiment it is provided that the limiter cable is displaceably fastened by a resistance to a fastening rail and, in particular, so that the resistance is higher than the resistances in normal operation. If, however, the speed limiter itself brakes, then it begins to move on the fastening rail. This takes place on the fastening rail up to an abutment, which triggers the safety brake device or in that it frees a coil, which is fastened at the bottom in the elevator shaft by a desired holding force, from its mounting so that it pulls the lever and linkage device of the safety brake device by a cable via the deflecting roller. The two last-mentioned variants of construction of an elevator installation offer—in correspondence with one of the two set objectives, namely making possible elevator installations without an engine room—additionally to the capability of remote actuation of the resetting device of the speed limiter and its remote triggering the possibility of managing entirely without an engine room.

### DESCRIPTION OF THE DRAWINGS

The invention is explained in more detail symbolically and by way of example on the basis of figures. The figures are described conjunctively and in general. The same reference numerals denote the same components and reference numerals with different indices indicate functionally equivalent or similar components. In that case:

FIG. 1 shows a schematic illustration of an elevator installation according to the prior art;

FIG. 2 shows a speed limiter in normal operational state;

FIG. 2a shows the speed limiter, which is shown in FIG. 2, illustrated—for better understanding—without cable pulley mounting and magnetic switch mounting;

FIG. 3 shows the speed limiter shortly before braking on the basis of a test, triggered by the magnetic switch;

FIG. 4 shows the speed limiter in the braking position;

FIG. 5 shows, again for better understanding, a perspective view of the speed limiter in the resetting position and in partially sectioned illustration; and

FIG. 6 shows a further perspective view of the speed limiter in the resetting position.

### DESCRIPTION OF PREFERRED EMBODIMENTS

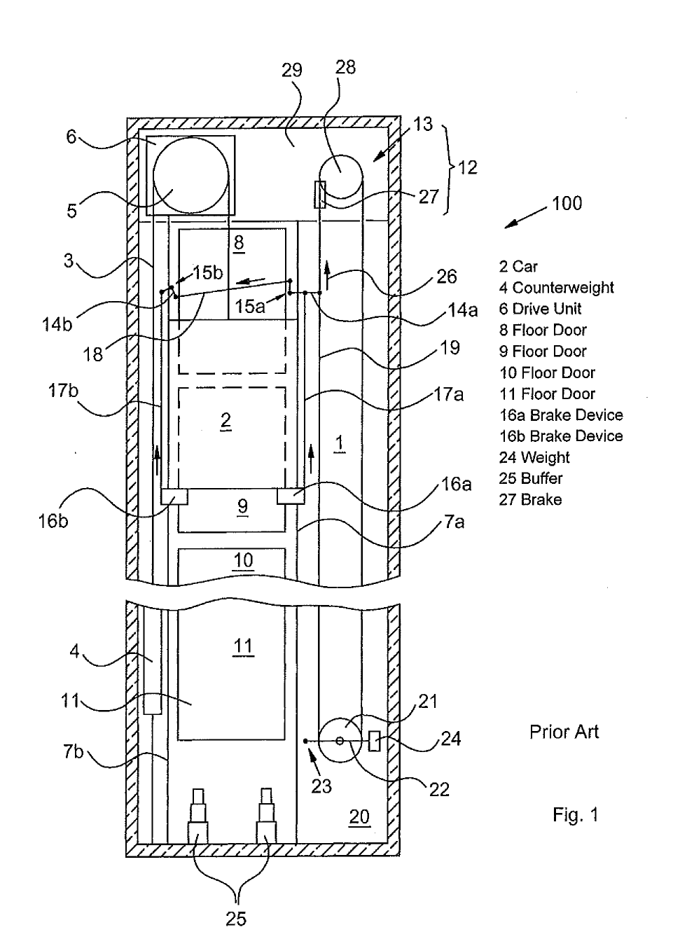

FIG. 1 schematically shows an elevator installation 100 such as corresponds with the prior art. It has an elevator car 2, which is movable in an elevator shaft 1 and is connected with a counterweight 4 by way of a support means 3. The support means 3 is, in operation, driven by a drive pulley 5 of a drive unit 6. The elevator car 2 and the counterweight 4 are guided by means of guide rails 7a and 7b extending over the shaft height.

The elevator installation 100 has an uppermost floor with an uppermost floor door 8, a second-uppermost floor with a second uppermost floor door 9, further floors with further floor doors 10 and a lowermost floor with a lowermost floor door 11. A shaft head 12 accommodates an engine room 29, in which the drive unit 6 and a speed limiter 13 are arranged, which stops the elevator car 2 in a case of excess speed. For this purpose a respective double lever 14a or 14b, which is respectively articulated at a fulcrum 15a or 15b at the elevator car 2, is arranged at each of two opposite sides of the elevator car 2. Moreover, the double lever 14a is fixedly connected with a limiter cable 19 of the speed limiter 13.

The limiter cable 19 is guided in the shaft head 12 over a cable pulley 28 of the speed limiter 13 and in a shaft pit 20 over a deflecting roller 21. During travel, the elevator car 2 drives the limiter cable 19, in which case the speed of the elevator car 2 is monitored by the speed limiter 13 via the limiter cable 19. In the case of excess speed of the elevator car 2 the speed limiter 13 brakes, by the brake 27, the movement of the limiter cable 19 and stops this. The limiter cable 19 thereby exerts on the double lever 14a an upwardly directed tension force in correspondence with the arrow direction 26. Thus actuated, the double lever 14a rotates about a fulcrum 15a. As a result, on the one hand a traction in upward direction is transmitted by way of a linkage 17a to a safety brake device 16a.

On the other hand, however, insofar as the elevator equipment 100 is equipped in accordance with a preferred embodiment—as illustrated—with a second safety brake device 16b coupled with the first safety brake device 16a, the double lever 14a additionally transmits a pressure movement to a connecting rod 18 by means of a rigid, approximately 90-degree bell crank which is articulated at its apex to the elevator car 2 in the fulcrum 15a. This connecting rod 18 in turn presses on the further, second double lever 14b, which similarly to the first double lever 14a is formed from a solid, approximately 90-degree bell crank, which is articulated at its apex to the elevator car 2 in the fulcrum 15b. The pressure of the connecting rod 18 thus produces a rotation of the double lever 14b and this in turn is transmitted by a linkage 17b as a traction movement to the second safety brake device 16b. In principle, however, it is also possible to couple the traction movement of the limiter cable 19 with a lever arrangement which triggers the safety brake device 16a, 16b not by pulling, but by pushing.

The endless limiter cable 19 is tensioned by means of the deflecting roller 21 arranged in the shaft pit 20 with buffers 25, wherein a roller axle mounting 22 is articulated at one end at a fulcrum 23 and at the other end carries a tensioning weight 24. The support means 3, as also the limiter cable 19, can be at least one steel-wire cable or aramide cable, a belt or band or a V-belt or wedge-ribbed belt.

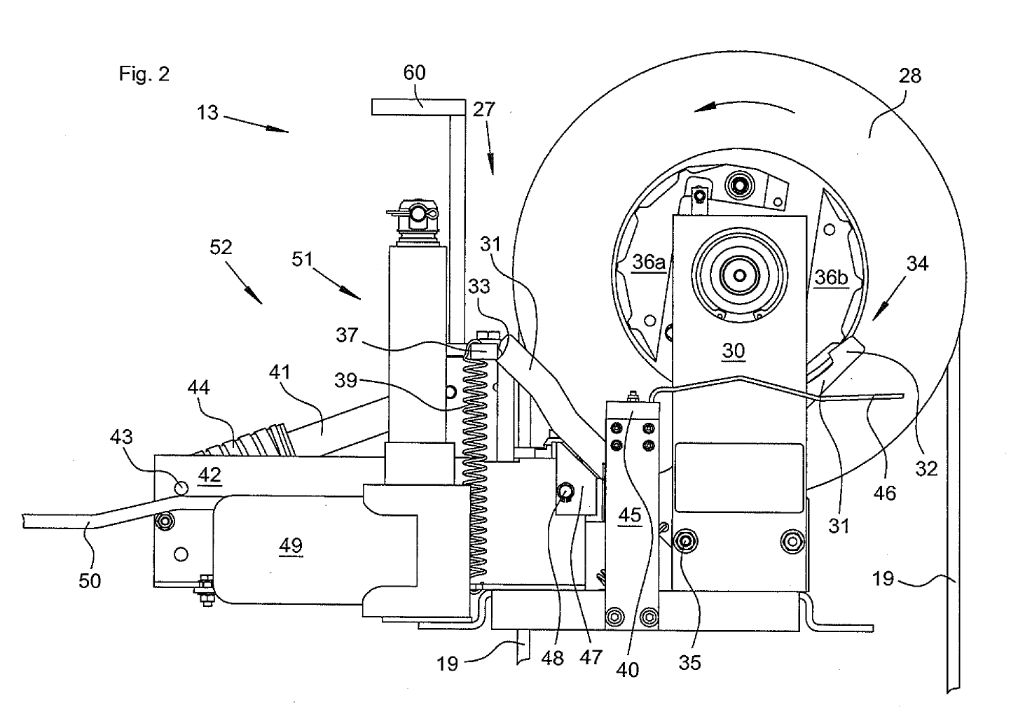

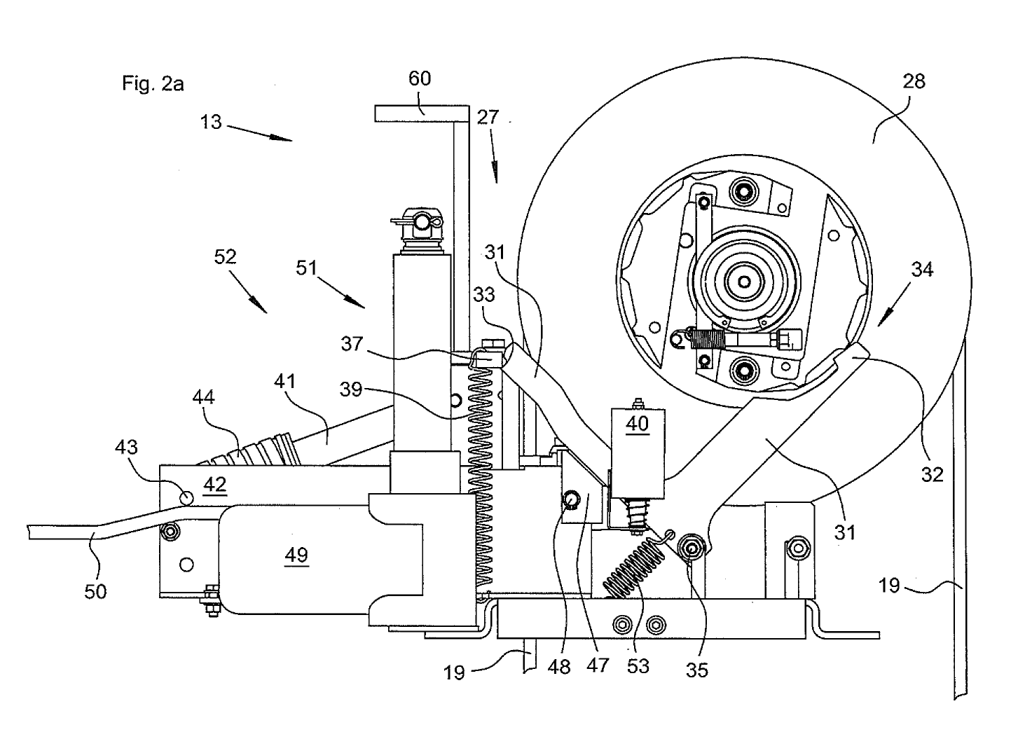

FIG. 2 schematically shows a speed limiter 13 which is disposed in the normal, non-braking operational state. The cable pulley 28 is arranged on a cable pulley mount 30 and the limiter cable 19 runs around the pulley. If the cable pulley 28 begins to rotate in the indicated rotational direction in anti-clockwise sense at a speed which exceeds a set target speed of the downward movement of the elevator car 2, centrifugal weights 36a and 36b moving outwardly due to the centrifugal force exert a pressure on a head 32 of a trigger lever 31 so that the trigger lever 31, which is of approximately right-angular shape and is rotatably fastened at an articulation point 35, executes at its opposite end with a mouth 33 a rotational movement oriented towards the center of the cable pulley 28. Due to this rotational movement the lower edge of the mouth 33 slides past the corner edge of a retaining plate 37 and thus allows a tension spring 39 to engage the brake lining or linings 38 (not visible in this figure) at the limiter cable 19 in a first contact braking position.

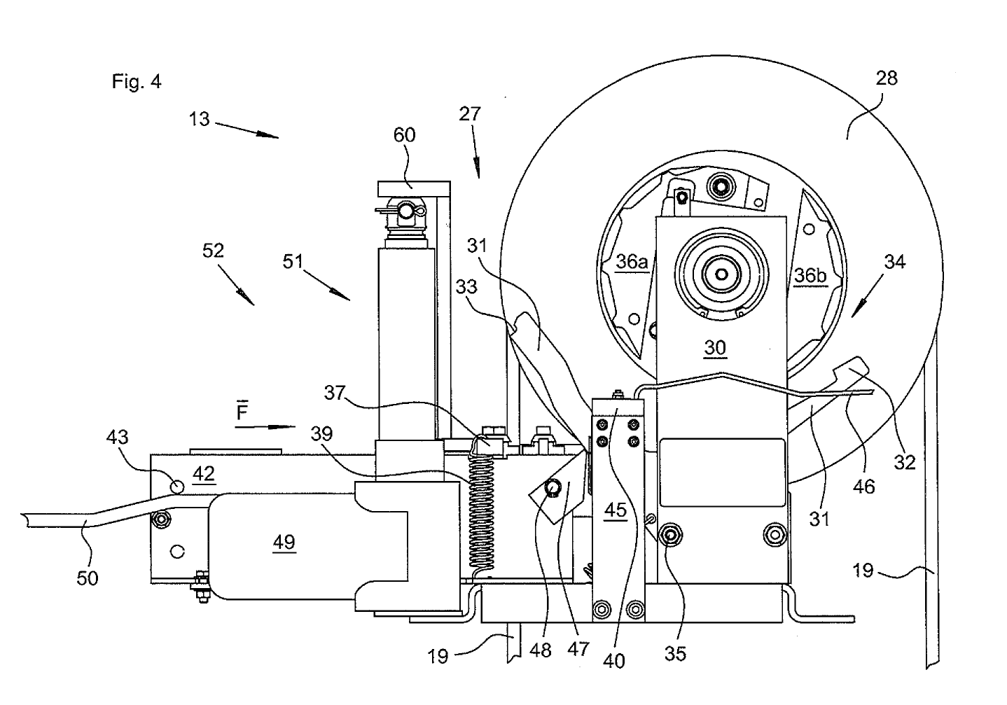

The brake lining 38 or brake linings 38 is or are mounted under spring loading to be displaceable, so that the brake lining or linings 38 after the first contact friction with the limiter cable 19 has come into being automatically draws or draw downwardly into the final braking position. However, additionally and independently of this design or mounting of the brake lining or linings 38 an automatically increasing braking force F (see FIG. 4) also builds up in that a brake lever 41 or preferably two brake levers 41 is or are arranged as a brace or braces. In this connection, the brake lever 41 is pivotably mounted in a housing 42 in a rotary bearing 43 and is loaded with a defined spring force by a spring 44. Arranged at the opposite end of the brake lever 41 is, for preference, a roller (not visible) by which the brake lever 41 applies the defined force of the spring 44 or its bracing force to the brake 27.

The speed limiter 13 thus has a trigger mechanism 34 which functions mechanically on the basis of triggering by the centrifugal weights 36a and 36b. As illustrated here, the centrifugal weights 36a and 36b are radially relatively far out so that in the case of a small increase in the rotational speed of the cable pulley 28 a triggering of the brake 27 would take place. Moreover, the speed limiter 13 has a further trigger possibility, namely by means of a magnetic switch 40. As well as in the case of mechanical triggering by means of the centrifugal weights 36a and 36b, the magnetic switch 40 is in a position of rotating the trigger lever 31 so that the mouth 33 frees the retaining plate 37. The magnetic switch 40 is arranged at a magnetic switch mount 45 and can be remotely operated by way of a remote trigger line 46. As already mentioned, however, mechanical or wire-free infrared or radio remote controls also come into consideration.

An abutment 47 with a chamfered edge is preferably rotatably and controllably arranged in a rotary bearing 48 so that a rotation in clockwise sense of the abutment 47 from the illustrated setting exerts a pressure on the trigger lever 31. In this manner a further, mechanical trigger mechanism is fundamentally realizable or, however, also only a fixing of the trigger lever 31, which would freely move back and forth after triggering of the brake 27.

The speed limiter 13 is equipped not only with a remote trigger for the brake 27, but also with a resetting device 52. After the braking position, which is illustrated in FIG. 4, of the brake 27 has been reached and the speed limiter 13 has to be set up for a fresh emergency or braking case, a drive 49 remotely controlled in accordance with the invention, for example by way of a remote resetting line 50, is in a position of so driving a drive system 51—here illustrated as a lifting system 51—that it again resets the brake 27 from the braking position, wedged against the limiter cable 19, by lifting of a lifting frame 60. The drive system 51 or lifting system 51 comprises, for example, a spindle drive, but can also comprise a rack drive or a pneumatic, hydraulic or electromagnetic drive.

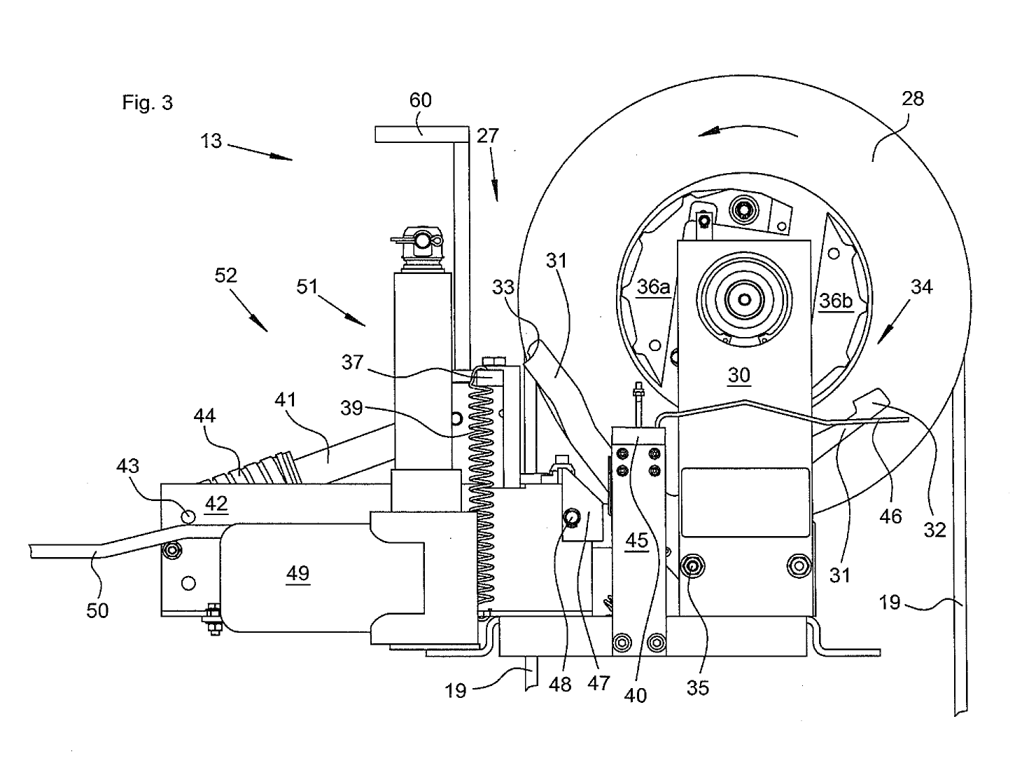

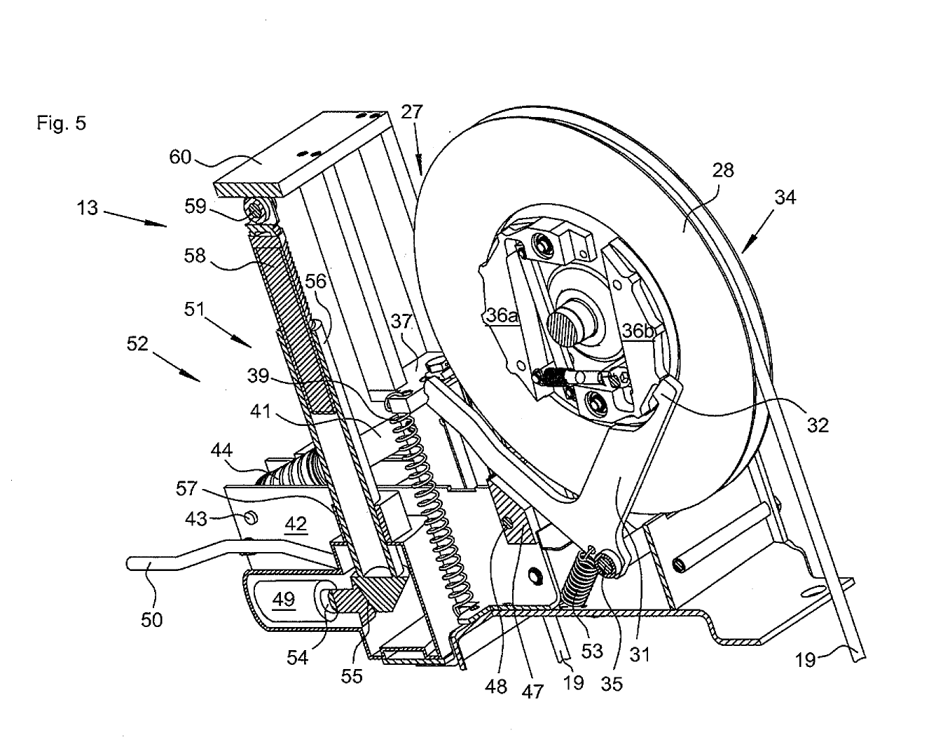

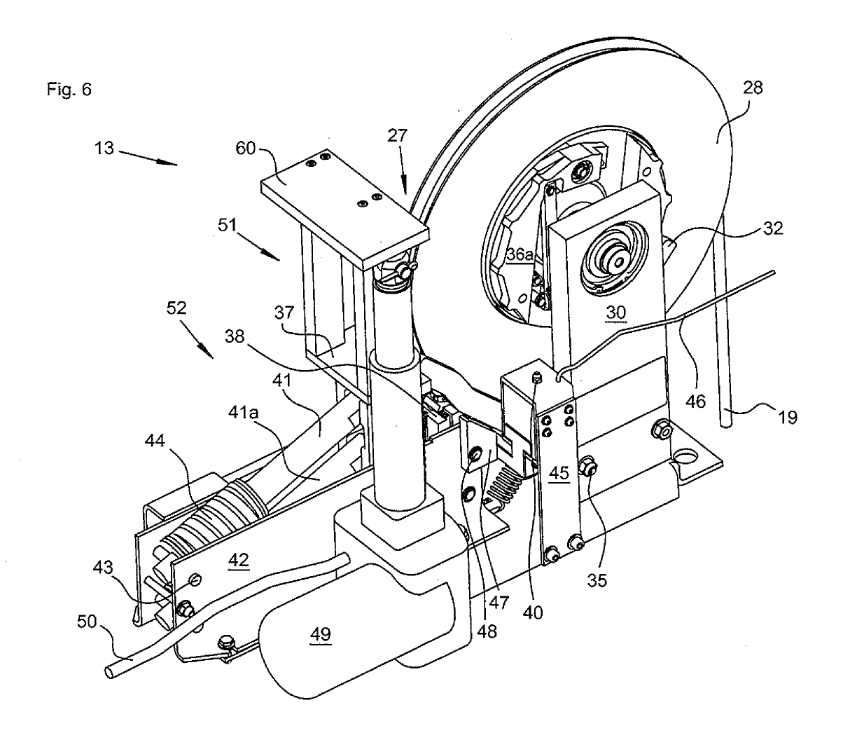

In FIGS. 2 and 3 the lifting system 51 with disengaged brake 27 is operationally ready for resetting, thus is shown moved in. In FIG. 4 the brake 27 is illustrated in engaged, braking setting and the lift system 51 thus directly before raising of the lifting frame 60, which is connected with the brake 27. FIGS. 5 and 6 show the moved-out lifting system 51 during resetting. FIG. 2 shows the speed limiter 13 in normal operational state, with operationally ready triggering and resetting function, i.e. the trigger lever 31 is detented, the brake 27 is disengaged and the magnetic switch 40 is not actuated. FIG. 3 shows, also like FIG. 2, in an operationally ready mode of the brake 27 and an operationally ready mode of a resetting device 52 (lifting system 51 moved in) the brief instant, which exists before shooting down of the brake 27, after the magnetic switch 40 has rotated the trigger lever 31 away. Because operationally ready modes are illustrated only in these two figures, the rotational direction of the cable pulley 28 corresponding with a downward movement of the elevator car 2 is also shown. In FIG. 2a, with the removed mounts, there cannot be assumption of a normal operational state.

The drive 49 is preferably designed so that it can execute not only the upward movement, called the resetting movement, for the brake 27, but also a downward movement into a fresh operationally ready setting for a fresh resetting movement for the brake 27.

FIG. 2a shows the speed limiter 13 with the resetting device 52, as it was already illustrated in FIG. 2, but for the sake of better clarity without the cable pulley mount 30 and the magnetic switch mount 45. It can be seen how the trigger lever 31 is shaped and also that a second tension spring 53 is arranged, which spring on the one hand draws the trigger lever 31 against the abutment 47 and on the other hand ensures biasing in the case of action of the centrifugal weights 36a and 36b on the head 32 of the trigger lever 31.

FIG. 3 schematically shows the previously illustrated speed limiter 13 with the resetting device 52 at the brief instant at which the magnetic switch 40 is triggered for, for example, test purposes and thereby has rotated the trigger lever 31 in clockwise sense. The mouth 33 no longer holds the retaining plate 37 and thus the brake 27 is applied.

The previously depicted speed limiter 13 is schematically illustrated in FIG. 4 with the resetting device 52 in the braking position of the brake 27. The triggering of the brake 27 could have been caused either by the centrifugal weights 36a and 36b or by the magnetic switch 40, but in either case the trigger lever 31 is removed from detenting and also further held by the abutment 47, which is rotated in clockwise sense, in this position removed from detenting. The magnetic switch 40 is back in its starting position. Due to the tension force of the tension spring 39 the brake 27 is engaged, i.e. closed. In this regard the brake lever 41 (not visible in this view) exerts in the illustrated direction a force F of approximately 0 to 2000 Newtons, preferably of approximately 0 to 1000 Newtons, on the limiter cable 19 enclosed in the brake 27.

FIG. 5 shows the speed limiter 13 with the resetting device 52 in perspective view obliquely from above right and in partial sectional illustration. With respect to function, this illustration corresponds with a concluded resetting process. The lifting system 51 has covered its working travel and the trigger lever 31 is detented again.

The lifting system 51 comprises, in the embodiment shown here, a drive shaft 54 which by means of a transmission 55 rotates a spindle nut 56 rotatably mounted by a spindle nut mount 57. A spindle 58 guided by a thread in the spindle nut 56 is fixedly connected at its upper end with the lifting frame 60 at an articulation point 59.

In the case of appropriate rotations of the spindle nut 56 the spindle 58 thus raises the lifting frame 60, which in turn is fixedly connected with the retaining plate 37. According to the invention the retaining plate 37 can thus perform a controlled upward movement for release of the brake 27. At the conclusion of the upwardly directed resetting movement the spindle 58 has to be moved downwardly again into its initial setting for fresh resetting. In order, in this regard, to avoid the retaining plate 37 and thus the brake linings 38 fixedly connected therewith being brought back into their braking position, decoupling of the downward movement has to be provided. This is ensured, as illustrated, in that the spindle 58 is not fixedly connected with the lifting frame 60.

A further variant of embodiment provides decoupling of the downward movement not between spindle 58 and lifting frame 60, but between the retaining plate 37 and the brake linings 38. The spindle 58 and the lifting frame 60 are in this regard fixedly connected together, but the retaining plate 37 has a spring-loaded entrainer. The entrainer has the effect that the retaining plate 37 entrains the brake linings 38 only in the case of its upward movement, but not in the case of its downward movement. This variant of embodiment is not illustrated in more detail, but this can be inferred from this description by an expert in the field of general engineering or lift installation construction. It is only important that a decoupling of the downward movement of the spindle 58 or the downwardly directed resetting movement of the resetting device 52 from the movement of the brake 27 takes place.

The retaining plate 37 can be fixedly connected with the brake lining or linings 38 so that the downward movement thereof can basically also be used for triggering of the brake 27, but the present invention is preferably confined to brake triggering either by the centrifugal weights 36a and 36b or by the magnetic switch 40.

The centrifugal weights 36a and 36b and/or the magnet switch 40 thus represents or represent the trigger mechanism 34 for the brake 27. Movement switches, actuators, linear piston motors or eccentrics come into consideration as other trigger mechanisms 34, such being so designed and arranged that they can produce a controlled, preferably remotely controlled, rotation of the trigger lever 31.

FIG. 6 shows the speed limiter 13, which is illustrated in FIG. 5, from a perspective full view obliquely from above left. It is apparent from this FIG. 6 that apart from the brake lever 41a second brake lever 41a is preferably arranged in parallel. In addition, the brake lining 38, against which the two brake levers 41 and 41a press the limiter cable 19 in the case of braking, is apparent from this perspective view.

In accordance with the provisions of the patent statutes, the present invention has been described in what is considered to represent its preferred embodiment. However, it should be noted that the invention can be practiced otherwise than as specifically illustrated and described without departing from its spirit or scope.

1-9. (canceled)

10. A speed limiter for an elevator installation, the speed limiter including a limiter cable, which can be braked by a brake of the speed limiter, and a resetting device, which can be triggered by remote actuation, for the brake, wherein the brake includes at least one brake lining, which is engageable with the limiter cable in a first contact braking position, and wherein the resetting device includes a drive system for releasing the at least one brake lining from engagement with the limiter cable in a final braking position, comprising:
a remotely actuable trigger including a magnetic switch acting on a trigger lever to cause the at least one brake lining to come into contact with the limiter cable in the first contact braking position under action of a spring-loaded brake lever; and
the at least one brake lining being mounted to be displaceable under spring-loading so that the at least one brake lining after moving to the first contact braking position with the limiter cable automatically moves into the final braking position.

11. The speed limiter according to claim 10 including a trigger mechanism for triggering the brake, with remote actuation, to move the at least one brake lining to the first contact braking position.

12. The speed limiter according to claim 10 wherein the drive system of the resetting device is a lifting system or a traction system with a deflecting roller.

13. The speed limiter according to claim 10 wherein the drive system of the resetting device is driven pneumatically or hydraulically.

14. The speed limiter according to claim 10 wherein the drive system of the resetting device is driven by one of a spindle, a rack and a spring-loaded mechanism.

15. The speed limiter according to claim 10 wherein the drive system of the resetting device is triggered by a traction cable or electromagnetically.

16. The speed limiter according to claim 10 wherein the drive system includes a drive for applying a resetting force in a range of 0 to 1000 Newtons to release the at least one brake lining of the brake.

17. The speed limiter according to claim 10 wherein the drive system includes a drive for applying a resetting force in a range of 0 to 2000 Newtons to release the at least one brake lining of the brake.

18. The speed limiter according to claim 10 including at least one wire-free receiver which is remotely operable by a wire-free transmitter for actuating the remotely actuable trigger.

19. The speed limiter according to claim 10 wherein the drive system includes a drive for moving the drive system upward and downward, wherein the at least one brake lining can be entrained by an entrainer only on upward movement of the drive system.

20. An elevator installation with a speed limiter comprising:
a limiter cable;
a brake having at least one brake lining, which is engageable with the limiter cable in a first contact braking position, the at least one brake lining being mounted to be displaceable under spring-loading so that the at least one brake lining after moving to the first contact braking position with the limiter cable automatically moves into a final braking position engaging the limiter cable; and
a resetting device, which can be triggered by remote actuation, for the brake, wherein the resetting device includes a drive system for releasing the at least one brake lining from engagement with the limiter cable in the final braking position.

21. The elevator installation according to claim 20 including a remotely actuable trigger including a magnetic switch acting on a trigger lever to cause the at least one brake lining to come into contact with the limiter cable in the first contact braking position under action of a spring-loaded brake lever.

22. The elevator installation according to claim 21 including at least one wire-free receiver which is remotely operable by a wire-free transmitter for actuating the remotely actuable trigger.

23. The elevator installation according to claim 20 wherein the drive system of the resetting device is a lifting system that acts on a lifting frame to release the at least one brake lining.

24. The elevator installation according to claim 23 wherein the drive system of the resetting device includes a spindle drive.

25. The elevator installation according to claim 20 wherein the drive system includes a drive for applying a resetting force in a range of 0 to 1000 Newtons to release the at least one brake lining of the brake.

26. The elevator installation according to claim 20 wherein the drive system includes a drive for applying a resetting force in a range of 0 to 2000 Newtons to release the at least one brake lining of the brake.

27. The elevator installation according to claim 20 wherein the drive system includes a drive for moving the drive system upward and downward, wherein the at least one brake lining can be entrained by an entrainer only on upward movement of the drive system.

28. A speed limiter for an elevator installation, the speed limiter including a limiter cable, which can be braked by a brake of the speed limiter, and wherein the brake includes at least one brake lining, which is engageable with the limiter cable in a first contact braking position, comprising:
a remotely actuable trigger including a magnetic switch acting on a trigger lever to cause the at least one brake lining to come into contact with the limiter cable in the first contact braking position under action of a spring-loaded brake lever;
the at least one brake lining being mounted to be displaceable under spring-loading so that the at least one brake lining after moving to the first contact braking position with the limiter cable automatically moves into a final braking position; and
a resetting device triggered by remote actuation and wherein the resetting device includes a drive system for releasing the at least one brake lining from engagement with the limiter cable in the final braking position.
